(19) United States
(12) Patent Application Publication
(10) Pub. No.: US 2007/0179703 A1
(43) Pub. Date: Aug. 2, 2007

(54) PROCESS TAKING INTO CONSIDERATION A LOCAL AND FAVORABLE METEOROLOGICAL SITUATION NOT CONFORMING TO A GENERAL METEOROLOGICAL FORECAST

(75) Inventors: Olivier SOUSSIEL, Fonsorbes (FR); Francois COULMEAU, Seilh (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/627,879

(22) Filed: Jan. 26, 2007

(30) Foreign Application Priority Data
Jan. 27, 2006 (FR) 06 00761

(51) Int. Cl. G01C 23/00

(52) U.S. Cl. 701/200; 701/3; 701/120

(57) ABSTRACT

This invention concerns a process taken into consideration when a nominal route is being followed between a departure airport and an arrival airport, of a flight plan established on the basis of a general meteorological forecast covering an area of the airspace containing the nominal route and in a time frame beginning before the date of the departure of the aircraft from the departure airport, for a local meteorological situation that is unfavorable and not conforming to the general meteorological forecast. According to the invention, the process includes detecting during in the following of the nominal route of the flight plan, unfavorable local situations not conforming to the general meteorological situation forecast and seeking an alternate route diverting around the local unfavorable meteorological situation detected, while taking into consideration the general meteorological situation forecast.

This invention concerns a process for the acknowledgement of a local unfavorable meteorological situation not conforming to a general meteorological forecast. In particular, the intervention applies to generating and using a database carried on an aircraft including meteorological data covering a space field encompassing a nominal route for a timeframe covering the expected duration for which this nominal route will be followed.

Generally speaking, an aircraft carries a flight management computer used by the pilot, for instance, to calculate a reference trajectory from a flight plan. Note that a flight plan contains a chaining together of segments. Each segment is defined from maneuvering instructions that the aircraft must comply with to go from one point to another; and these instructions are defined by means of mandatory and/or optional parameters and are listed in a navigation database of the computer. Points of passage and/or waypoints are listed in the published navigation databases addressing standard ARINC-424 and allowing the definition of the most generally used airborne corridors although the pilot can define his own waypoints.

The reference trajectory from the departure airport to the destination airport is calculated from these segments which include lateral and vertical constraints, based on altitude, speed and time constraints and the context of the aircraft such as the consumption, the weight of the aircraft, the passenger comfort rules (roll angle, load factor) and the meteorological conditions, such as wind, temperature, pressure.

The meteorological conditions taken into consideration to calculate the reference trajectory, also called the nominal route, are loaded into the aircraft before its departure. The meteorological conditions are transmitted in the form of predictive meteorological data to locations corresponding to the ends of the flight plan segments, in other words, corresponding to the positions of the waypoints, for the foreseeable date of aircraft passage. These meteorological data give a predictive picture of the meteorological situation the field of which is reduced to the aircraft reference trajectory. The meteorological data transmitted to the aircraft consist of a static prediction of the meteorological situation.

When an aircraft encounters on its flight an unfavorable meteorological situation that does not conform to the expected meteorological situation, for instance a cloud in the process of forming, or a storm, it may be required to deviate slightly from the reference trajectory. As soon as it leaves the nominal route, the pilot of the aircraft is obliged to abandon the nominal flight plan and generate an alternate flight plan.

In the previous embodiment of the technique, the alternate flight plan is generated on the basis of the meteorological data available in the aircraft alone, that is, from the data forming the predictive picture. By construction, this data is unsuitable because it represents values associated with places or with dates that, in theory, do not correspond to the waypoints of the alternate flight plan. Nevertheless, despite their unsuitability, these are the meteorological data taken into consideration to determine the alternate flight plan by means of an implicit hypothesis of data stability.

The acknowledgement on incorrect meteorological data to establish an aircraft route layout, at the extreme, may have considerable consequences on the safety of the flight, and more frequently, an impact on the pilot's capability of generating an alternate route he can follow effectively. This latter drawback is all the more penalizing in that the punctuality of civil passenger transport aircraft is becoming a major challenge facing airlines and thus airline pilots because of the policy maintained by the air traffic control organizations, aimed at optimizing the use of airports by imposing, under threat of financial penalties, precise dates of passage at predefined waypoints in the airspace.

One important purpose of the invention is therefore to overcome these drawbacks.

To achieve this goal, the invention proposes a process taken into consideration when a nominal route is being followed between a departure airport and an arrival airport, of a flight plan established on the basis of a general meteorological forecast covering an area of the airspace containing the nominal route and in a time frame beginning before the date of the departure of the aircraft from the departure airport, for a local meteorological situation that is unfavorable and not conforming to the general meteorological forecast, characterized in that it includes the following steps:
detecting during in the following of the nominal route of the flight plan, unfavorable local situations not conforming to the general meteorological situation forecast;
seeking an alternate route diverting around the local unfavourable meteorological situation detected, while taking into consideration the general meteorological situation forecast.

This invention makes it possible to adjust, during the flight, to a meteorological situation requiring the aircraft to move away considerably from the nominal route established on the ground, for instance, and to generate an alternate route based on more relevant meteorological data than that considered as the technique now stands

According to one characteristic of the invention, the general meteorological situation forecast is acquired on the basis of meteorological data values at positions of the airspace transmitted to the aircraft and by interpolations of these meteorological data values accomplished on the aircraft.

According to another characteristic of the intervention, the general meteorological situation forecast is generated on the ground on the basis of meteorological data values at points of the airspace and interpolations of the meteorological data values then transmitted to the aircraft in the form of meteorological data development law parameters.

Other characteristics and advantages of the invention will appear from the reading of the detailed description that follows, given as a non-limitative example, and by reference to the attached illustrations in which:

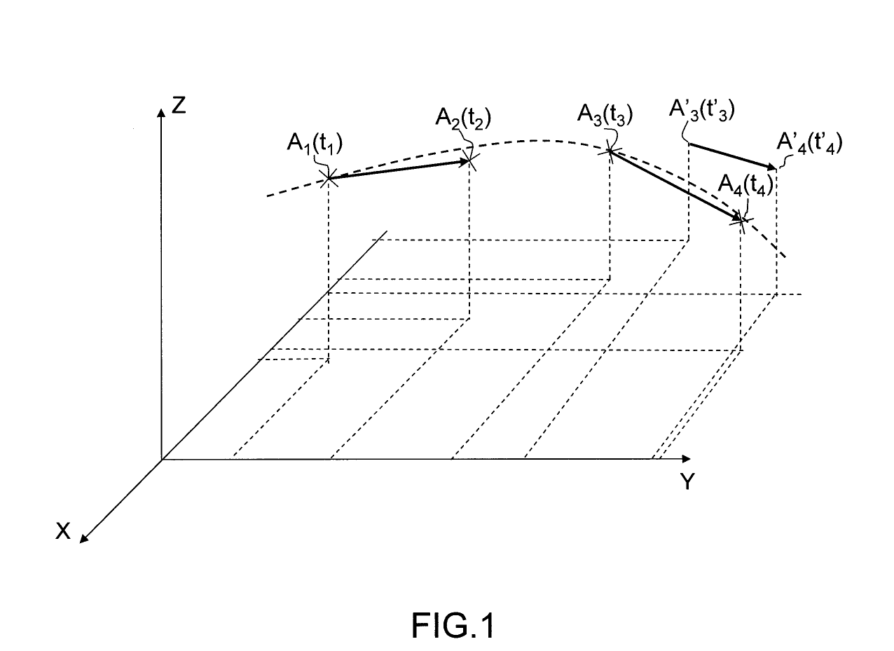

FIG. 1 is a three-dimensional view of a flight plan and the arrangement of the location in space for which the meteorological data values are transmitted to the aircraft to establish a nominal route according to the prior embodiment of the technique,

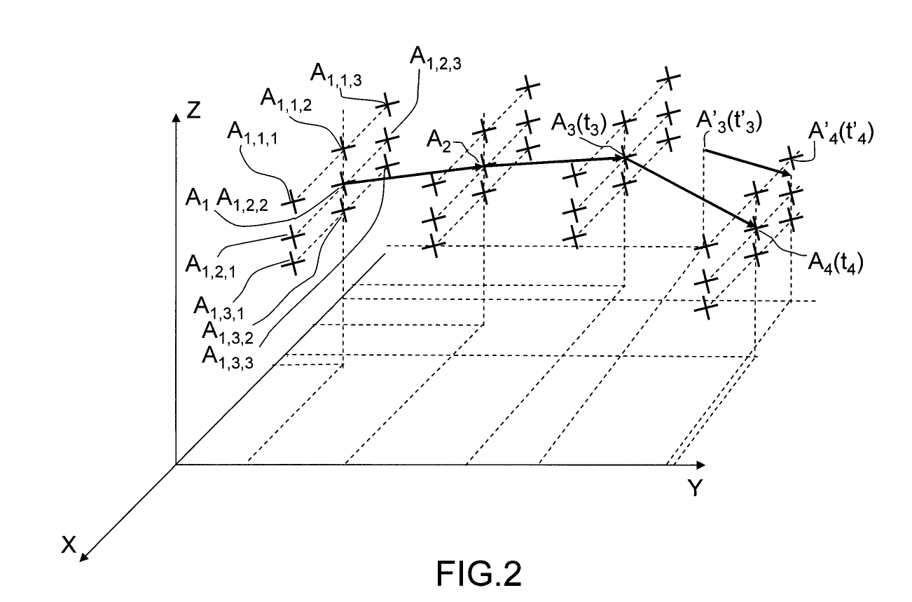

FIG. 2 is a three-dimensional view of a flight plan and the arrangement of the location in space for which the meteorological data values are transmitted to the aircraft to establish an alternate route, according to the invention,

From one figure to the other, the same elements are identified by the same references.

FIG. 1 is a three-dimensional view representing a succession of segments forming the nominal flight plan of an aircraft. The ends of the segments are waypoints whose positions are defined either manually by the pilot automatically by the aircraft instruments, in which case the positions of the waypoints derive from published navigation databases.

A nominal aircraft route representing a forecast of the route being followed is generated by the pilot of the aircraft before his aircraft takes off. The nominal route is shown in FIG. 1 by a dotted line curve. The layout takes the flight plan into consideration, represented by straight line segments with arrowheads, and a series of constraints some of which are meteorological, for instance, the local wind direction, the strength of the wind, the atmospheric pressure and also, the air temperature.

In FIG. 1, the Z axis represents the vertical direction and the X and Y axes on the ground plane. Crosses depict the points in space for which the data values are estimated. These meteorological data values obtained from estimations and meteorological forecast calculations made and commercialized by companies and/or government organizations. All these meteorological data form a meteorological situation forecast, generally, supplied by the airport authorities or by the airline operating the aircraft, using a dedicated radio connection.

As the technique now stands, the meteorological data used by the pilot to evaluate his route comprise physical magnitudes, for instance the local wind direction, the strength of the wind, the air pressure and also the meteorological air temperature, solely at the waypoints, estimated at the predicted date of passage of the aircraft. The predicted data passage of the aircraft is determined by establishing the hypothesis of a rectilinear path at a uniform speed between two consecutive waypoints on the flight plan. If the date of passage scheduled for point A₁ is t₁, the predicted meteorological situation for point A₁ transmitted to the aircraft, corresponds to date t₁. The meteorological situation forecast supplied to the aircraft pilot is constrained in terms of time and space. This characteristic is a source of difficulties for the pilot when he requires to modify the nominal route being followed by his aircraft. Indeed, in a situation like this, the aircraft can attempt to join the nominal route with a delay on the schedule provided for on the nominal cause, or to take a new route. In both cases, it has to establish an alternate flight plan A′₃(t′₃) A′₄(t′₄) and set up an alternate route based on the associated ecological data. But the only atmospheric data available to the pilot does not correspond to the new dates of passage t′₃, t′₄, or does not correspond to positions A′₃, A′₄ of the waypoints on the alternate flight plan.

As the technique now stands, these difficulties are resolved by considering that the on-board meteorological data is similar to that needed to establish an alternate route. With this hypothesis, it is possible to associate the estimated meteorological data for waypoint A₃ at t₃ with an alternate waypoint A′₃ at date t′₃ and in doing so, associate the estimated meteorological data for waypoint A₄ at date t₄ with an alternate waypoint A′₄ at date t′₄, which is probably true if waypoints A₃ and A′₃ on the one hand and waypoints A₄ and A′₄ on the other hand are not too remote from one and other, but may otherwise be false.

To overcome these difficulties, for all the possible cases, one solution according to the invention consists in supplying the pilot of the aircraft, before the departure of his aircraft, with a forecast of the general meteorological situation which is evolutionary. This means that the forecast of the general meteorological situation covers a field of the airspace containing the nominal route and a time segment beginning before the scheduled date of the aircraft departure and ending after a stipulated predicted aircraft arrival date. This leads to making a forecast of the meteorological situation in a geographical area where the aircraft may take up a position, within a timeframe covering the predicted time during which the nominal route will be followed. This meteorological situation forecast can be considered to be evolutionary because it is no longer confined only to the waypoints of the nominal flight plan.

It is advantageous to load the general meteorological situation forecast on the aircraft before the aircraft leaves the departure airport, to establish the original general meteorological situation forecast.

At the request of the pilot, it is also possible to load in the route of the flight, a new general meteorological situation forecast which updates the original general meteorological situation forecast. A need for this type of update may occur, for instance, when the meteorological situation encountered has degraded considerably compared to the general original meteorological situation forecast, in other words, if the original general meteorological situation forecast is wrong or if the pilot of an aircraft on a very long haul flight wishes to refresh the forecast of a general meteorological situation generated by a meteorological forecasting organisation located spatially near the departure airport by a general meteorological situation forecast issued by another meteorological forecasting organisation spatially close to the arrival airport, from which the pilot may expect a more recent and more relevant forecast.

It is advantageous to load the general meteorological situation forecast on the aircraft after the aircraft leaves the departure airport, to replace the original general meteorological situation forecast.

It is desirable to have a grid with an extensive spatial scope so as to be able to take into consideration changes of route that may be significant, for instance as in the case of a diversion around a very strong local depression, not appearing in the general meteorological situation forecast.

The borders of the domain are determined as an envelope of points of the grid, that is, points at which the meteorological data are calculated. These points are subsequently referred to it as additional points.

Advantageously, the spatial domain has borders that are at least 100 nautical miles away from the nominal route.

Advantageously, the timeframe begins at the latest one hour before the scheduled departure time of the aircraft from the departure airport.

Advantageously, the timeframe ends at the earliest three hours after the scheduled arrival time of the aircraft at the destination airport.

In an initial embodiment, the general meteorological situation forecast can consist of a grid of space and time values for meteorological data supplied by a meteorological forecasting organization. The grid is loaded on the aircraft before its departure or during the flight. When the aircraft pilot establishes an alternate fight plan based on knowledge of the effective position of the aircraft, he has sufficient items in hand to generate an alternate route based on meteorological data that is relevant in terms of space and time. The values of the meteorological data at the positions of the waypoints included in the alternate flight plan are determined by space and time interpolation of the data making up the grid.

In a second embodiment, meteorological data variation laws are loaded into the aircraft, obtained by prior space and time interpolations on the ground, of a grid similar to the one presented in the initial embodiment. The loading of the variation laws can take place by communication from the ground to the aircraft of analytical functions that approximate physical magnitude variation laws. The communication of analytical functions may be in the form, for instance, of the transmission of Legendre polynomial coefficients to approximate an air temperature space-time variation law near the waypoints of an alternate flight plan. This second embodiment has the advantage over the first embodiment of requiring a far smaller volume of data are to be loaded on the aircraft, which may be a particular advantage to shorten the loading time required for meteorological data.

It is desirable that the grid includes a great number of additional points to minimize the inaccuracy of the spatial interpolations. Similarly, it is desirable that the dates on which the meteorological data is estimated or calculated be numerous in order to minimize the inaccuracy of any time related interpolations.

FIG. 2 represents a three-dimensional view of a typical grid in space and time involving meteorological data. In this figure, around the position of each waypoint of the nominal flight plan, eight additional points have been set out regularly on the X axis, Y axis and Z axis. The regular arrangement is chosen simply to facilitate the graphic representation; according to the invention, the arrangement of the additional points may be irregular and, accordingly, the grid may be irregular.

For instance, eight additional points (A_{1,i,j}) with 0<i<4 and 0<j<4 are arranged around waypoint A₁ which is also named A_{1,2,2}. According to the initial flight plan, the route of the aircraft passes through waypoint A₁ at date t₁. At these additional points, we determine the values of the meteorological data calculated or estimated for dates falling within a timeframe covering the initially scheduled flight duration. All these data items form the meteorological data grid.

A grid like this is used when an inadvertent modification is made to the flight plan, for instance, because of a local meteorological situation being encountered that is not compliant with the general meteorological forecast, to evaluate an alternate route the following of which is all the easier in that its layout is based on relevant meteorological data.

Advantageously, when the flight plan includes at least one passage waypoint with a required time constraint; keeping to the set time constraint while following the nominal route of the flight plan is facilitated by taking into consideration the general meteorological situation forecast.

1. A process taken into consideration when a nominal route is being followed between a departure airport and an arrival airport, of a flight plan established on the basis of a general meteorological forecast covering an area of the airspace including the nominal route and in a time frame beginning before the date of the departure of the aircraft from the departure airport, for a local meteorological situation that is unfavorable and not conforming to the general meteorological forecast,
comprising the following steps:
detecting during in the following of the nominal route of the flight plan, unfavorable local situations not conforming to the general meteorological situation forecast;
seeking an alternate route diverting around the local unfavorable meteorological situation detected, while taking into consideration the general meteorological situation forecast.

2. The process according to claim 1, when the flight plan includes at least one passage waypoint with a required time constraint, keeping to the set time constraint while following the nominal route of the flight plan is facilitated by taking into consideration the general meteorological situation forecast.

3. The process according to claim 1 wherein the general meteorological situation forecast includes data concerning the direction of the wind.

4. The process according to claim 1 wherein the general meteorological situation forecast includes data concerning the strength of the wind.

5. The process according to claim 1 wherein the general meteorological situation forecast includes data concerning the atmospheric pressure.

6. The process according to claim 1 wherein the general meteorological situation forecast includes data concerning the temperature of the air.

7. The process according to claim 1, wherein the general meteorological situation forecast is acquired on the basis of meteorological data values at positions of the airspace transmitted to the aircraft and by interpolations of these meteorological data values accomplished on the aircraft.

8. The process according to claim 1, wherein the general meteorological situation forecast is generated on the ground on the basis of meteorological data values at waypoints of the airspace and interpolations of the meteorological data values then transmitted to the aircraft in the form of meteorological data development law parameters.

9. The process according to claim 1, wherein the time range begins at the latest one hour before the scheduled departure time of the aircraft from the departure airport.

10. The process according to claim 1, wherein the time range ends at the earliest three hours after the scheduled arrival time of the aircraft at the destination airport.

11. The process according to claim 1, wherein the spatial domain has borders that are at least 100 nautical miles away from the nominal route.

12. The process according to claim 1, wherein a general meteorological situation forecast is loaded onto the aircraft before the aircraft leaves the departure airport, to establish the original general meteorological situation forecast.

13. The process according to claim 1, wherein a general meteorological situation forecast is loaded onto the aircraft after the aircraft leaves the departure airport, to replace the original general meteorological situation forecast.

14. The process according to claim 2, wherein the general meteorological situation forecast includes data concerning the direction of the wind.

15. The process according to claim 2, wherein the general meteorological situation forecast includes data concerning the strength of the wind.

16. The process according to claim 2, wherein the general meteorological situation forecast includes data concerning the atmospheric pressure.

17. The process according to claim 2, wherein the general meteorological situation forecast includes data concerning the temperature of the air.

18. The process according to claim 2, wherein the general meteorological situation forecast is acquired on the basis of meteorological data values at positions of the airspace transmitted to the aircraft and by interpolations of these meteorological data values accomplished on the aircraft.

19. The process according to claim 2, wherein the general meteorological situation forecast is generated on the ground on the basis of meteorological data values at waypoints of the airspace and interpolations of the meteorological data values then transmitted to the aircraft in the form of meteorological data development law parameters.

20. The process according to claim 2, wherein a general meteorological situation forecast is loaded onto the aircraft after the aircraft leaves the departure airport, to replace the original general meteorological situation forecast.
